(19) United States
(12) Patent Application Publication
(10) Pub. No.: US 2024/0028710 A1
(43) Pub. Date: Jan. 25, 2024

(54) METHOD AND APPARATUS FOR DETERMINING WHETHER A PROCESSING UNIT IS COMPLIANT WITH A SECURITY POLICY

(71) Applicant: Hewlett-Packard Development Company, L.P., Spring, TX (US)

(72) Inventors: Christopher Ian Dalton, Bristol (GB); Pierre Louis Robert Belgarric, Bristol (GB); David Julien Plaquin, Bristol (GB); Peter Siyuan Zhang, Spring, TX (US); Qijun Steve Chen, Spring, TX (US)

(73) Assignee: Hewlett-Packard Development Company, L.P., Spring, TX (US)

(21) Appl. No.: 18/255,942

(22) PCT Filed: Dec. 11, 2020
(86) PCT No.: PCT/US2020/064560

§ 371 Date: Jun. 5, 2023

(51) Int. Cl. G06F 21/54; G06F 21/44; G06F 21/53; G06F 21/75

(52) U.S. Cl. CPC G06F 21/54; G06F 21/44; G06F 21/53; G06F 21/755

(57) ABSTRACT

A method of determining whether a processing unit is compliant with a security policy is provided. The method may comprise obtaining first data indicative of a power consumption profile of the processing unit for a first time period, the power consumption profile comprising a variation of power consumption with time. The method may comprise determining whether the processing unit is compliant with the security policy during the first time period depending, at least in part, on the obtained first data. It may be that the processing unit complying with the security policy gives rise to a power signature in the power consumption profile of the processing unit during a period of compliance.

### BACKGROUND

Solutions for determining whether a processing unit is compliant with a security policy may include, for example, mechanisms such as secure boot, measured boot, and runtime integrity measurements. These mechanisms may be vulnerable to so-called “digital attack” techniques whereby malicious code may invalidate the result of these mechanism by falsifying their output.

### BRIEF INTRODUCTION OF THE DRAWINGS

Example implementations are described below with reference to the accompanying drawings, in which:

FIG. 1 is a schematic diagram of functional blocks of a computing system;

FIG. 2 is a schematic diagram of functional blocks of a computing system utilising a type 1 hypervisor to implement a virtual machine;

FIG. 3 is a schematic diagram of functional blocks of a computing system utilising a type 2 hypervisor to implement a virtual machine;

FIG. 4 is an example characteristic increased power consumption in a power consumption profile of a CPU;

FIG. 5 is an example of a plurality of characteristic power spikes in a power consumption profile of a CPU;

FIG. 6 is an example of a plurality of periods of characteristic reduced power consumption in a power consumption profile of a CPU;

FIG. 7 is an example flowchart for determining whether a processing unit is compliant with a security policy; and

FIG. 8 is an example flowchart for causing a mitigating action depending on determining a lack of compliance of a processing unit with a security policy.

### DETAILED DESCRIPTION

The present disclosure may be applicable to any type of processor or processing unit. In the following description it is assumed, however, that the discussed processor is a central processing unit.

FIG. 1 is a schematic diagram of functional blocks of a computing system 100. The computing system 100 may correspond to any type of computing system, such as, for example: a supercomputer; a mainframe; a server or a cluster of servers; a distributed computing system; a real-time computing system; an embedded computing system; a personal computer such as, for example, a desktop computer or a laptop computer; a handheld computer such as, for example, a smart phone or a tablet; a wearable computer, such as, for example, a smart watch; or any other type of computing system.

The computing system 100 may comprise a central processing unit, CPU, 110. The computing system may further comprise system resources 115, 120. The computing system 100 may further comprise a security policy compliance block 130. The computing system 100 may further comprise a power source 140.

The system resources may include system resources 120 external to the CPU 110, system resources 115 integrated within the CPU 110 or system resources 120 external to the CPU 110 and system resources 115 integrated within the CPU 110. In some examples, the system resources 120 may include, for example, any of: hardware registers; memory; a graphics controller; an input/output controller, which may be communicatively coupled to a peripheral device, such as, for example, a display or a keyboard or any other type of input/out device; power management circuitry; firmware; network interface circuitry; or any other type of system resource of a computing system, such as a computing system of a type mentioned above. In some examples, the system resources 115 may include, for example, any of: a plurality of registers, including, for example, data registers, address register, general-purpose registers, a stack pointer, or any other type of register; cache memory; or any other type of system resource which may be integrated within the CPU of a computing system, such as a computing system of a type mentioned above.

The CPU 110 may be any type of processor such as, for example: a general-purpose processor; a digital signal processor; a microcontroller; a microprocessor; an embedded processor; or any other type of processor capable of executing machine-readable instructions. The CPU 110 may have any type of architecture and may use any type of instruction set architecture. In some examples, the CPU 110 may utilise a complex instruction set computer (CISC) architecture, such as, for example, any version of the x86 architecture or any other CISC architecture. In other examples, the CPU 110 may utilise a reduced instruction set computer (RISC) architecture, such as, for example, any version the Advanced RISC Machines (ARM) architecture, including, for example, any version of the ARM V8 architecture, or any other RISC architecture. The CPU 110 may comprise any number of processing cores. For example, the CPU 110 may be any one of: a single-core CPU having a single processing core; a dual-core CPU having two processor cores; a quad-core CPU having four processing cores; a multi-core CPU having a plurality of processing cores including any number of processing cores greater than one.

The CPU 110 may be operable to implement a security policy or a plurality of security policies. An example security policy may comprise executing, by the CPU 110, at least one operating system in a virtual machine. As disclosed herein, complying with this example security policy may serve to isolate code being executed by the said virtual machine from system resources, such as the system resources 115 or the system resources 120, for example, to thereby protect the system resources of the computing system 100 from misuse or corruption by the said code being executed by the said virtual machine. Another example of a security policy may comprise invoking a secure mode or a plurality of secure modes. For example, the secure mode may be a system management mode (SMM) of the CPU, which may be invoked periodically or intermittently. The SMM may provide a mechanism by which the integrity of trusted code, such as kernel code, for example, can be monitored and verified.

Solutions for determining whether a CPU is compliant with a security policy may include, for example, mechanisms such as secure boot, measured boot, and runtime integrity measurements. These mechanisms may be vulnerable to so-called “digital attack” techniques whereby malicious code may invalidate the result of these mechanism by falsifying their output. Complying with a security policy or a plurality of security policies, such as those identified above, may give rise to a power signature in a power consumption profile of a corresponding compliant CPU. The power signature may be characteristic (e.g. at least indicative) of the CPU being compliant with the said security policy or policies. Accordingly, it may be determined whether a CPU, such as the CPU 110, for example, is compliant with a security policy by: obtaining first data indicative of a power consumption profile of the CPU for a first time period, the power consumption profile comprising a variation of power consumption with time; and determining whether the CPU is compliant with the security policy during the first time period depending, at least in part, on the obtained first data; wherein the CPU complying with the security policy gives rise to a power signature in the power consumption profile of the CPU during a period of compliance. By determining compliance of the processing unit with a security policy based on power consumption variation with time, it can be more reliably determined that the processing unit has not succumbed to a so-called digital attack causing malicious code to run thereon. This is because falsifying a power consumption profile is more difficult to achieve by such malicious code than other ways in which compliance of the processing unit with security policies may be indicated, such as flag setting. This helps to improve the security of the processing unit.

The particular power signature, which may be characteristic (e.g. at least indicative) of a CPU which is compliant with a security policy or security policies may depend on the particular security policy or policies to be complied with. In some examples, as disclosed hereinafter, the particular power signature associated with a given security policy or policies may depend on a given mode or modes of the CPU which may be invoked by the said security policy or polices.

In some examples, the CPU 110 may be operable to execute a virtual machine, or a plurality of virtual machines to comply with the security policy. As used herein, a virtual machine refers to a virtual environment which emulates a computer system in which software, such as an operating system, for example, can be executed. A virtual machine may be virtual in the sense that system resources of a virtual machine do not have a direct correspondence to physical hardware, but rather, the said system resources are emulated by a computing system, such as the computing system 100, for example, which may be referred to as a “host”. Accordingly, virtual machines may serve to isolate software which they are executing from system resources of their host, thereby mitigating against untrusted software, such as malware, for example, running on the virtual machine misusing or corrupting some or all of the said system resources. Each instance of a virtual machine running on a host may referred to as a “guest”. In some examples, a plurality of virtual machines may each run their own respective operating systems, each of which may run in isolation from each other.

The virtual machine or plurality of virtual machines may be implemented utilising a hypervisor. As used herein, a hypervisor refers to software, firmware, hardware, or any combination thereof which creates and controls the execution of a virtual machine or a plurality of virtual machines. A hypervisor may alternatively be known as a virtual machine monitor (VMM), or by any other suitable name.

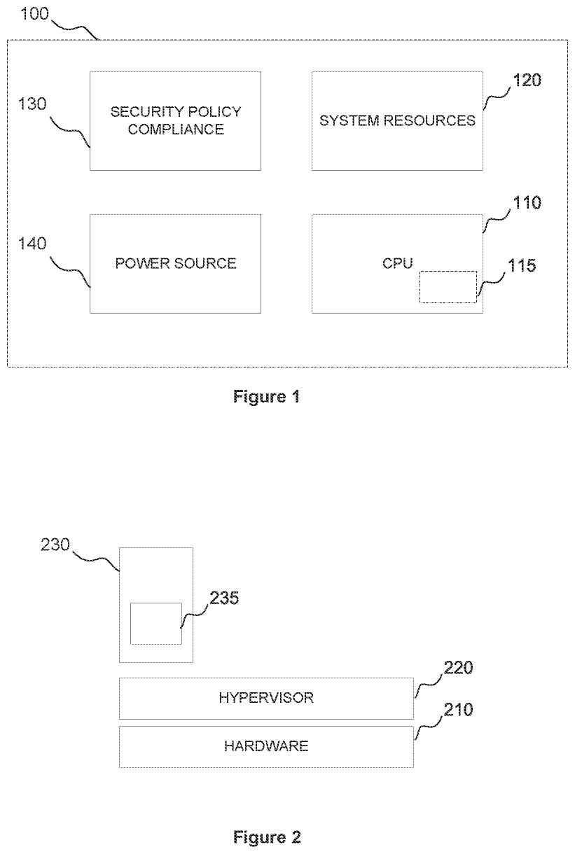

In some examples, the above mentioned hypervisor may be a type 1 hypervisor. As used herein, a type 1 hypervisor refers to a hypervisor which runs directly on the hardware of its host (e.g., the hardware of the computing system in which the hypervisor is operating). A type 1 hypervisor may also be referred to as a “native” or “bare-metal” hypervisor. FIG. 2 is a schematic diagram of functional blocks of a computing system utilising a type 1 hypervisor to implement a virtual machine. As shown, these functional blocks include hardware 210, a hypervisor 220, a virtual machine 230 and a guest operating system 235. While the example shown in FIG. 2 illustrates a computing system utilising a type 1 hypervisor to implement one virtual machine, the present disclosure is not so limited, and a computing system, such as the computing system 100, for example, may utilise a type 1 hypervisor to implement a plurality of virtual machines.

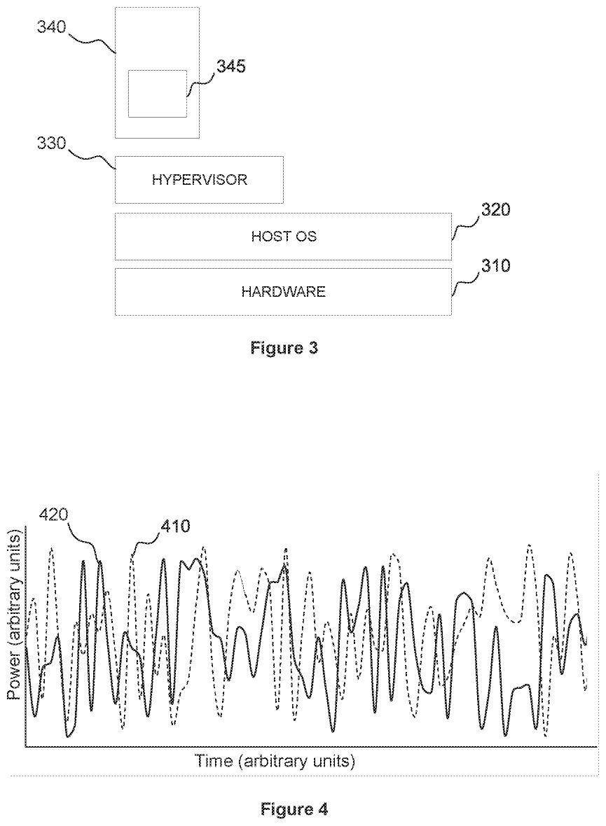

In some examples, the above-mentioned hypervisor may be a type 2 hypervisor. As used herein, a type 2 hypervisor refers to a hypervisor which does not run directly on its host's hardware, but rather, runs on an operating system, wherein the said operating system runs directly on its host's hardware. A type 2 hypervisor may also be referred to as a “hosted” hypervisor. FIG. 3 is a schematic diagram of functional blocks of a computing system utilising a type 2 hypervisor to implement a virtual machine. As shown, these functional blocks include hardware 310, a host operating system 320, a hypervisor 330, a virtual machine 340, and a guest operating system 345. While the example shown in FIG. 3 illustrates a computing system utilising a type 2 hypervisor to implement one guest virtual machine, the present disclosure is not so limited, and a computing system, such as the computing system 100, for example, may utilise a type 2 hypervisor to implement a plurality of guest virtual machines.

In some examples, the above-mentioned hypervisor may be any other type of hypervisor, such as for example, a so-called “micro-visor”, a type 1.5 hypervisor, or a Kernel-based Virtual Machine (KVM) for example. Hypervisors such as a KVM or a type 1.5 hypervisor may, for example, correspond to a combination of type 1 and type 2 hypervisors.

Executing software in a virtual machine implemented on a host computing system, such as the computing system 100, for example, may consume more power than running the same or substantially identical software directly on the hardware of the said computing system, or on substantially identical hardware of a substantially identical computing system. This may be the case for software running on any type of hypervisor, such as a type 1 hypervisor, a type 2 hypervisor or a type 1.5 hypervisor, for example.

Software, such as an operating system, for example, running on a hypervisor may consume more power than the same or substantially identical software running directly on the hardware of the said computing system, or on substantially identical hardware of a substantially identical computing system, because, for example, there may be an associated overhead in terms of power consumption related to the hypervisor communicating with the host operating system in order to control the guest operating system. For example, it may take a greater number of instructions executed by a CPU, such as the CPU 110, for example, in order for a guest operating system running in a virtual machine implemented utilising a hypervisor to implement a given functionality, such as, for example, saving a value to a region of a memory, than it would for a host operating system running directly on its host's hardware to implement the same or a substantially similar given functionality. The said greater number of instructions may include, for example, instructions related to facilitating communication between the guest operating system of the virtual machine and the host operating system.

Accordingly, running software, such as an operating system, for example, in a virtual machine on the CPU 110 may give rise to a characteristic increased power consumption in a power consumption profile of the CPU 110, at least during a time period in which the said software is running. The said characteristic increased power consumption may be characteristic of (e.g. at least indicative that) the said software is running in a virtual machine.

As used herein, the term “characteristic” is used to refer to a feature or features of a power consumption profile which may be expected to be present in a power consumption profile of the CPU 110 during a period of compliance with a corresponding security policy or policies, such as, for example, any one of or any combination of the security policies disclosed herein. That the said feature or features are characteristic (e.g. expected) of compliance of the CPU 110 with the security policy or policies may have been (e.g. empirically) determined or predetermined based on, for example: modelling an expected power consumption profile of the CPU 110 during a period of compliance with the corresponding security policy or policies; a measurement or measurements of the power consumption profile of the (or a similar) CPU 110 during a (e.g. prior, e.g. test) period of compliance with the corresponding security policy or policies; or any combination thereof.

In some examples, feature(s) of the power consumption profile of the CPU 110 which are characteristic of compliance with a corresponding security policy or security policies may be present in a power consumption profile of the CPU 110 when the CPU 110 is compliant with the corresponding security policy or policies, for example during normal operation of the CPU 110 (e.g., without actively attempting to invoke the said characteristic features in the power consumption profile of the CPU 110, for example without executing or running a predefined test workload such as by way of an exerciser such as a software exerciser on the CPU 110). In these examples, the said characteristic feature(s) may uniquely identify the CPU 110 as complying with the corresponding security policy or policies, or at least indicate that the CPU 110 is more likely to be complying with the corresponding security policy or policies than if no such characteristic feature(s) were present in the power consumption profile.

In other examples, as will be discussed further below, feature(s) of the power consumption profile of the CPU 110 which are characteristic of compliance with a corresponding security policy or policies may be actively invoked (e.g., by executing or running a predefined test workload on the CPU 110, such as by way of an exerciser, such as a software exerciser) in the power consumption profile of the CPU 110 during a first time period for the purpose of determining if the CPU 110 is compliant with a given security policy or policies. The active invoking of feature(s) in the power consumption profile of the CPU 110 which are characteristic of compliance with a corresponding security policy or policies may be based on causing the CPU 110 to execute or perform a predefined test workload. As above, an expected power consumption profile of the CPU 110 (or feature(s) thereof) for executing the predefined workload while complying with the security policy or policies may have been (e.g. empirically) determined or predetermined based on, for example: modelling an expected power consumption profile of the CPU 110 during a period of compliance with the corresponding security policy or policies when executing or performing the predefined workload; a measurement or measurements of the power consumption profile of the (or a similar) CPU 110 during a (e.g. prior, e.g. test) period of compliance with the corresponding security policy or policies when executing or performing the predefined workload; or any combination thereof. When the CPU 110 is caused to execute or perform the predefined workload during a first time period, the presence of characteristic (e.g., expected) feature(s) in the power consumption profile of the CPU 110 during the first time period may thus be attributed to compliance, by the CPU 110, with the corresponding security policy or policies. By predetermining the power consumption profile of the CPU 110 (or feature(s) thereof) when the CPU 110 is executing or performing the predefined workload in compliance with the security policy or policies, the characteristic feature(s) of the power consumption profile can be may be more robustly distinguished from other features(s) which may be present in the power consumption profile of the CPU 110 and which may be caused by factors other than compliance, by the CPU 110, with the security policy or policies.

In some examples, a power signature associated with software, such as an operating system, for example, running in a virtual machine may comprise the characteristic increased power consumption in a power consumption profile of the CPU 110. The power consumption profile may comprise a variation in power consumption with time. In examples wherein the CPU 110 comprises a single processing core, the said power consumption profile may correspond to a power consumption associated with the single processing core of the CPU 110.

In examples wherein the CPU 110 comprises a plurality of processing cores, the said power consumption profile may correspond to a power consumption associated with any of: a single processing core of the plurality of processing cores; each processing core of the plurality of processing cores; each processing core of a subset of processing cores of the plurality of processing cores, the subset of processing cores comprising a plurality of cores.

A power consumption profile may comprise an aggregate power consumption profile comprising an aggregation of a variation of power consumption with time of the processing cores of the said subset of the said plurality, or of the respective processing cores of the said plurality. Alternatively, the said power consumption profile may comprise individual respective variations of power consumption with time of the respective processing cores of the said subset of the said plurality, or of the said plurality.

In some examples, a characteristic of the said characteristic increased power consumption may be that a power consumption profile having the characteristic increased power consumption comprises a greater power consumption in comparison to a corresponding power consumption profile associated with (e.g., resulting from) running the same or substantially identical software (e.g., as the software running on the CPU exhibiting the characteristic increased power consumption) directly (e.g., not in a hypervisor) on the same or a substantially identical CPU (e.g., the same as or identical to that CPU exhibiting the characteristic increased power consumption) of the same, or of a similar computing system. The said greater power consumption may be greater in the sense that the average (e.g., mean) power consumption of the said power consumption profile having the characteristic increased power consumption is greater than an average (e.g., mean) power consumption of the said corresponding power consumption profile. Additionally or alternatively, the said greater power consumption may be greater in the sense that said power consumption profile having the characteristic increased power consumption comprises at least one peak power consumption value greater than a peak power consumption value of the said corresponding power consumption profile.

As will be discussed further below, in some examples, the CPU 110 may be caused to execute a predefined workload or a plurality of predefined workloads (for example, by way of an exerciser such as a software exerciser) for the purposes of determining if the CPU 110 is compliant with the security policy. The predefined workload or plurality of predefined workloads may give rise to a power signature in a power consumption profile of the CPU 110 during the execution of the said predefined workload or workloads when the CPU 110 is compliant with the security policy, wherein the power signature may comprise a characteristic increased power consumption, such as the characteristic increased power consumption discussed above, or any other characteristic increased power consumption disclosed herein. The predefined workload or plurality of predefined workloads may give rise to a known average power consumption and/or a known peak power consumption value when the CPU 110 is compliant with the security policy. Accordingly, causing execution of the said predefined workload or plurality of workloads may enable the characteristic increased power consumption to be attributed to compliance with the security policy and distinguished from other causes of increased power consumption.

FIG. 4 shows an example of a power signature comprising a characteristic increased power consumption in a power consumption profile 410 of a CPU, such as the CPU 110, for example, for a first time period, during which the CPU may be utilising a hypervisor to execute software in a virtual machine. The power consumption profile 410 may be a power consumption profile of a single processing core of the CPU, or may be an aggregate power consumption profile as described above.

The said characteristic increased power consumption may be characteristic of (e.g. at least indicative that) the said CPU is executing the said software in a virtual machine. The hypervisor may be a type 2 hypervisor, for example. While the example power consumption profile 410 comprises a particular variation of power consumption with time, this is merely an example of one such characteristic increased power consumption in a power consumption profile, and the present disclosure is not so limited. FIG. 4 also shows an example of a power consumption profile 420 of a CPU, which may be the same as or substantially identical to the CPU 110, for a corresponding first time period, during which the said CPU may be directly executing software the same as or substantially identical to the software being executed by the said virtual machine associated with the power consumption profile 410. At least by comparison to the power consumption profile 420, It can be seen that the power consumption profile 410 comprises a power signature comprising a characteristic increased power consumption. For example, the power consumption profile 410 may comprise a characteristic increased power consumption in that the average (e.g. mean) power consumption of the power consumption profile 410 during the first time period is greater than the average (e.g. mean) power consumption of the power consumption profile 420 during the first time period. As another example, the power consumption profile 410 may comprise a characteristic increased power consumption in that the peak value of power consumption of the power consumption profile 410 during the first time period is greater than the peak value of power consumption of the power consumption profile 420 during the first time period.

As will be discussed further below, the security policy compliance block 130 may detect the above-mentioned characteristic increased power consumption in a power consumption profile of the CPU 110 and based on the said detection may determine if the CPU 110 is executing at least one operating system in a virtual machine, and thereby determine if the CPU 110 is complying with the security policy depending thereon.

The CPU 110 may be operable in each of a plurality of (e.g. different) privilege modes. Each privilege mode of the plurality may have a corresponding (e.g. different) privilege level in terms of system resources that can be accessed in that mode. For example, the privilege level corresponding to each mode may give the CPU a respective selected set of access rights to system resources when the CPU is operating in that mode. The access rights may be different in different privilege modes, corresponding to different privilege levels. The said system resources may include, for example, the external system resources 120, the integrated system resources 115 or the external system resources 120 and the integrated system resources 115.

The said plurality of privilege modes may include a most privileged mode. The most privileged mode may provide the CPU 110 with access to all system resources including, for example, the external system resources 120 and the integrated system resources 115. That is, when operating in the most privileged mode, the CPU 110 may be able to execute instructions which cause any of the external or integrated system resources to be accessed.

The said plurality of privilege modes may include a least privileged mode. The CPU may be prevented from accessing some or all of the system resources, such as some or all of the external system resources 120, some or all of the integrated system resources 115 or some or all of the external system resources 120 and some or all of the integrated system resources 115, when operating in the least privileged mode. That is, when operating in the least privileged mode, the CPU may be restricted from executing instructions which cause at least selected system resources of the external system resources 120, at least selected system resources of the integrated system resources 115 or at least selected system resources of the external system resources 120 and at least selected system resources of the integrated system resources 115 to be accessed. In some examples, when operating in the least privileged mode, the CPU may be prevented from accessing any system resources, such as any of the external system resources 120, any of the integrated system resources 115 or any of the external system resources 120 and any of the integrated system resources 115.

The said plurality of privilege modes may include an intermediate privilege mode. The CPU may have less access to system resources, for example to system resources including the external system resources 120, the integrated system resources 115 or the external system resources 120 and the integrated system resources 115, than in the most privileged mode but more access to the system resources than in the least privileged mode. In some examples, the said plurality of privilege modes may include a plurality of intermediate privilege modes wherein each intermediate privilege mode has a different level of access to system resources than in each other intermediate privilege mode, and wherein in each intermediate mode of the said plurality the CPU has less access to system resources, for example including the external system resources 120, the integrated system resources 115 or the external system resources 120 and the system resources 115, than in the most privileged mode, but more access to the said system resources than in the least privileged mode.

The said plurality of different privilege modes may be utilised to control access to system resources, such as the external system resources 120, the integrated system resources 115 or the external system resources 120 and the integrated system resources 115, depending on a program being executed by the CPU. For example, applications being executed on the CPU may operate in the least privileged mode. In some example, this mode may be referred to as a “user-mode”, “ring-3” mode, or “Exception Level (EL) 0”. Because such applications are executed in the least privileged mode, they may be unable to directly access some or all of the system resources, such as some or all of the external system resources 120, some or all of the integrated system resources 115 or some or all of the external system resources 120 and some or all of the integrated system resources 115, and thus, may be unable to either intentionally or unintentionally misuse or corrupt said system resources.

In some examples, operation in more privileged modes than the least privileged mode, such as, for example, in the most privileged mode, is restricted to trusted code, such as, for example, kernel code of an operative system or hypervisor code of a type 1 hypervisor. Accordingly, it may be that direct access to the system resources is reserved for trusted code. In some examples, the most trusted mode may be referred to as “kernel mode”, “supervisor mode”, “ring-0” mode, or “Exception Level (EL) 3”.

In some examples, code which may be partially trusted, such as device driver code, for example, may operate in an intermediate privilege mode, and thus, such partially trusted code may have some direct access to the system resources, including for example the external system resources 120, the integrated system resources 115 or the external system resources 120 and the integrated system resources 115. In some examples, the said plurality of intermediate privilege modes may include modes referred to as “ring-2” mode(s) and “ring-1” mode(s).

In some examples, in order for program code executing in a given privilege mode, such as, for example, an intermediate privilege mode or the least privileged mode, to cause a desired access to a system resource beyond the access rights of that mode, the said code may invoke a transition of the CPU to a more privileged mode such as the most privileged mode. It may be that, upon such a transition, trusted code, such as kernel code or hypervisor type 1 code, for example, may execute instructions to cause the desired access. In some examples, such mode transitions may occur by way of a system call (such as, for example, “file open”, or any other type of system call) made by, for example, an application operating in the lesser or least privileged mode. In other examples, transitions to the more privileged mode such as the most privileged mode from the lesser (e.g. least) privileged mode, may occur due to, for example, timer interrupts used by, for example, an operating system (OS) scheduler.

Transitioning from a given mode of the plurality of modes of the CPU 110 to a different given mode of the said plurality may give rise to a power signature in a power consumption profile of the CPU 110 during a time period in which the said transition occurs. The characteristics of the said power signature may depend on the particular transition which occurs, as discussed hereinafter. For example, the characteristics of the said power signature may depend on the particular mode of the CPU being transitioned to. Additionally or alternatively, the characteristics of the said power signature may depend on the particular mode of the CPU being transitioned from. The said power signature may be characteristic of (e.g. at least indicative that) a particular transition has occurred.

In some examples, the CPU being compliant with the security policy may comprise the CPU transitioning between lower and greater privilege modes (e.g. in either direction or in both directions). In some examples, at least part of the above-discussed power signature may be indicative of the processing unit transitioning between lower and greater privilege modes (e.g. in either direction or in both directions). In some examples, the power signature may depend on a mode of the CPU to be invoked to comply with the security policy. In some examples, the power consumption profile of the CPU during the first time period may be indicative of a privilege level or a plurality of privilege levels of the CPU during the first time period. In some examples, the CPU complying with the security policy may comprise the CPU having a security policy compliant privilege level or a plurality of security policy compliant privilege levels during a period of compliance with the security policy.

As will be discussed further below, the security policy compliance block 130 may determine a compliance of a CPU, such as the CPU 110, for example, with a security policy depending, at least in part, on a power signature of a power consumption profile of the said CPU, wherein the power signature may be characteristic (e.g. at least indicative) of a particular mode transition of the CPU, for example, between lesser and greater privileged modes, such as from a lesser privileged mode to a more privileged mode, from a more privileged mode to a lesser privileged mode, or both, to comply with the security policy.

In some examples, transitioning from a given lesser privileged mode, such as the least privileged mode, to a more privileged mode, such as the most privileged mode may in general comprise saving, to a memory, a current state of the CPU corresponding to the said given lesser privilege mode prior to transitioning to the more privileged mode. In some examples, transitioning back from the said more privileged mode to the said given lesser privileged mode may in general comprise, restoring, from the memory, the said current state of the CPU corresponding to the said given lesser privilege mode prior to having transitioned to the said more privileged mode. As discussed below, the specific characteristics of such transitions may depend on the specific privilege mode being transitioned from or to.

In some examples, the said plurality of privilege modes of the CPU 110 may include a privilege mode or a plurality of privilege modes which enable the CPU 110 to execute software, such as an operating system (e.g., a guest operating system), for example, in a virtual machine or a plurality of virtual machines utilising a type 1 hypervisor or any other type of hypervisor. Such a mode or modes may be referred to as a virtualization mode or virtualization modes.

In some examples, the virtualization mode or virtualization modes may enable the operation of a type 1 hypervisor or any other type hypervisor which utilises a virtualization-specific mode or modes. In the following, reference is made to a type 1 hypervisor for simplicity, however, the present disclosure is not so limited, and any discussion relating to a type 1 hypervisor may also be applicable to any other type of hypervisor utilizing the discussed virtualization-specific mode or modes, such as, for example, a type 1.5 hypervisor, or a type 2 hypervisor. In some examples, the CPU 110 may operate a type 1 hypervisor by: executing code corresponding to the type 1 hypervisor in a first virtualization mode providing the CPU with a first level of access to the system resources, such as the external system resources 120, the integrated system resources 115 or the external system resources 120 and the integrated system resources 115, and executing software, such as a guest OS being executed within a virtual machine, in a second privilege mode, which may be a second virtualization mode, providing the CPU with a second level of access to the said system resources, wherein the CPU has greater (e.g. more privileged) access to the said system resources in the first level of access than the second level of access. Operating the hypervisor may thus involve transitioning between the first virtualization mode and the second privilege mode.

In examples wherein the CPU 110 utilises an X86 architecture, the said first virtualization mode may be referred to as a root-mode, and the second privilege mode may be referred to as a non-root mode. In examples wherein the CPU 110 utilises an ARM architecture, such as the ARM V8 architecture, for example, the said first virtualization mode may be referred to as “Exception Level (EL) 2” and the second privilege mode may be referred to as “Exception Level (EL) 1”.

In some examples, while operating in the second privilege mode, the said guest software may invoke or cause a transition to the first virtualization mode, for example, depending on or responsive to certain events to comply with the security policy. For example, such a transition may be caused or invoked if the guest software attempts to access resources beyond its privilege level, such as, for example, if the guest attempts to update a privileged system resource, such as a privileged processor state, for example.

When a CPU executes an OS directly on the CPU (e.g., the OS runs on so-called “bare-metal”) it may be that transitions between privilege modes of the CPU include a transition from a lesser, such as the least, privileged mode, which may be, for example, a user-mode, “ring-3” mode, or “EL0”, in which an application may be being executed by the CPU, to a more privileged mode, such as the most, privileged mode, which may be, for example, a kernel mode, a supervisor mode, “ring-0” mode, or “EL3”. Transitioning from the lesser privileged mode to the more privileged mode may comprise: saving, to a memory, a current state of the CPU corresponding to the state of the CPU in the lesser privileged mode, wherein saving the current state of the CPU comprises saving the values of critical registers forming part of the system resources, such as, for example, a stack pointer; updating the said critical registers with values corresponding to the more privileged mode, including, for example, updating the stack pointer such that it points to a page (e.g., a region) of a memory specific to the more privileged mode; and executing program code corresponding to the more privileged mode. The CPU may comprise a plurality of processing cores. It may be that any or each processing core of the said plurality of processing cores transitions from the lesser privileged mode to the more privileged mode in this manner. Furthermore, any processing core of the said plurality may do so independently of any other processing core of the plurality. For example, one processing core, a subset of processing cores, or each processing core of the said plurality may transition from the lesser privileged mode to the more privileged mode without interrupting the execution of any of the remaining processing cores of the said plurality. In some examples, the above-described CPU state saving process may be implemented predominantly in software by, for example, the kernel of the OS, and the said current state of the CPU may be saved in a region of the memory which is controlled by software, for example, the kernel of the OS.

The way in which the CPU 110 transitions from the second privilege mode to the first virtualization mode may differ to the way in which a CPU executing an OS directly transitions from, for example, a user mode to a kernel mode as described above. In some examples relating to a type 1 hypervisor, the state of each constituent guest or virtual machine may be stored in a corresponding virtualization data structure. In examples in which the CPU utilises an X86 architecture, the virtualization data structure may be referred to as a virtual machine control structure (VMCS). Each virtualization data structure may be stored in a physical page or pages (a region or regions) of a memory. In some examples, reading from and writing to elements of each constituent virtualization data structure may be controlled by a hardware virtualization interface. In these examples, access to each constituent virtualization data structure may be made via the said hardware virtualization interface. Such access via the said hardware virtualization interface may be achieved by executing certain virtualization instructions which may be selectively executable by the CPU in, for example, the first virtualization mode. Such virtualization instructions may include, for example, VMREAD and VMWRITE. In some examples, a single virtualization data structure may be active on a core of the CPU 110 at one time, and instructions causing access to respective virtualization data structures may not be executed concurrently by a plurality of cores of the CPU 110, but rather the CPU 110 may be restricted to a single processing core thereof executing instructions to cause access to its respective virtualisation data structure at any one time. In these examples, said single core of the CPU may be referred to as the core which is executing instructions associated with the first virtualization mode.

In some examples, prior to transitioning from the second privilege mode to the first virtualization mode, a virtualization data structure corresponding to the guest software causing or invoking the said transition may be updated. Updating the said virtualization data structure may be a power intensive process. In some examples, updating the said virtualization data structure may be a more power intensive process than, for example, saving a current processor state when transitioning from, for example, a user mode to a kernel mode in a CPU on which an OS is executing directly as described above. Accordingly, in some examples, transitioning from the second virtualization mode to the first virtualization mode may give rise a to a first characteristic power spike in a power consumption profile of the CPU 110, at least during a time period in which the said transition occurs. The first characteristic power spike may be characteristic (e.g. at least indicative) of this particular transition. In some examples, the magnitude of the first characteristic power spike may be characteristic (e.g. at least indicative) of this particular transition. For example, the first characteristic power spike may have a (e.g. relative or absolute) magnitude lying between a predetermined upper and lower bound which may be characteristic (e.g. at least indicative) of this particular transition. In some examples, the duration of the first characteristic power spike may be characteristic (e.g. at least indicative) of this particular transition. For example, the first characteristic power spike may have a duration lying between a predetermined upper and lower bound, wherein the said duration may be characteristic (e.g. at least indicative) of this particular transition. In some examples, the said predetermined upper and lower bounds relating to the first characteristic power spike magnitude and duration may be predetermined using any suitable means. For example, the said upper and lower bounds may be predetermined based on a previous measurement or previous measurements of the said magnitude, duration or magnitude and duration of the said first characteristic power spike. In some examples, machine learning techniques may be utilised to identify the said upper and lower bounds, or indeed, any other signature which may be characteristic (e.g. at least indicative) of the said particular transition.

In some examples, the CPU 110 may transition from the first virtualization mode to the second privilege mode, for example to comply with a security policy. In these examples, any virtual machines which are to be executed in the second privilege mode, including, for example, a single virtual machine or a plurality of virtual machines, may have their respective virtualization data structure(s) restored. The said virtualization data structures may be restored, using, for example, a VMRESUME instruction. Restoring the said virtualization data structure or structures may be a power intensive process. In some examples, restoring the said virtualization data structure or structures may be a more power intensive process than, for example, restoring a current processor state of the CPU when transition from, for example, a kernel mode to a user mode in a CPU on which an OS is executing directly as described above. Accordingly, in some examples, transitioning from the first virtualization mode to the second virtualization mode may give rise a to a second characteristic power spike in a power consumption profile of the CPU 110, at least during a time period in which the said transition occurs. The second characteristic power spike may be characteristic (e.g. at least indicative) of this particular transition. In some examples, the magnitude of the second characteristic power spike may be characteristic (e.g. at least indicative) of this particular transition. For example, the second characteristic power spike may have a (e.g. relative or absolute) magnitude lying between a predetermined upper and lower bound may be characteristic (e.g. at least indicative) of this particular transition. In some examples, the duration of the second characteristic power spike may be characteristic (e.g. at least indicative) of this particular transition. For example, the second characteristic power spike may have a duration lying between a predetermined upper and lower bound may be characteristic (e.g. at least indicative) of this particular transition. In some examples, the said predetermined upper and lower bounds relating to the second characteristic power spike magnitude and duration may be predetermined using any suitable means. For example, the said upper and lower bounds may be predetermined based on a previous measurement or previous measurements of the said magnitude, duration or magnitude and duration of the second characteristic power spike. In some examples, machine learning techniques may be utilised to identify the said upper and lower bounds, or indeed, any other signature which may be characteristic (e.g. at least indicative) of the said particular transition.

In some examples, a power signature associated with transitioning from the second privilege mode to the first virtualization mode, or the first virtualization mode to the second privilege mode, may comprise a power spike in a power consumption profile of the CPU 110. In these examples, the said power spike may indicative that a transition from the second virtualization mode to the first virtualization mode, or a transition from the first virtualization mode has occurred. In some examples, a power signature associated with transitioning from the second virtualization mode to the first virtualization mode may comprise a first characteristic power spike in a power consumption profile of the CPU, wherein the first characteristic power spike is characteristic (e.g. at least indicative) of this particular mode transition. In some examples, a power signature associated with transitioning from the first virtualization mode to the second virtualization mode may comprise a second characteristic power spike in a power consumption profile of the CPU, wherein the second characteristic power spike is characteristic (e.g. at least indicative) of this particular mode transition. The power consumption profile may comprise a variation in power consumption with time. In examples wherein the CPU 110 is a single core, the said power consumption profile may correspond to a power consumption associated with the single core of the processor. In examples wherein the CPU 110 comprises a plurality of processing cores, the said power consumption profile may correspond to a power consumption associated with at least one processing core of the plurality of cores executing instructions associated with the first virtualization mode. The said power consumption profile may correspond to a power consumption associated with any of: a single processing core of the plurality of processing cores, the single core executing instructions associated with the first virtualization mode; each processing core of the plurality of processing cores; each processing core of a subset of processing cores of the plurality of processing cores, the subset of processing cores comprising a plurality of cores and including said single core executing instructions associated with the first virtualization mode.

In some examples where the CPU comprises a plurality of processing cores, the power consumption profile may comprise an aggregate power consumption profile comprising an aggregation of a variation of power consumption with time of the processing cores of the said subset of the said plurality, or of the processing cores of the said plurality. In these examples, the said power spike may be present in the said aggregate power consumption profile.

Alternatively, the said power consumption profile may comprise respective individual variations of power consumption with time of each respective processing core of the said subset of the said plurality, or of each respective processing core of the said plurality. In these examples, the said power spike may be present in the individual variation of power consumption with time of the processing core which is executing instructions associated with the first virtualization mode.

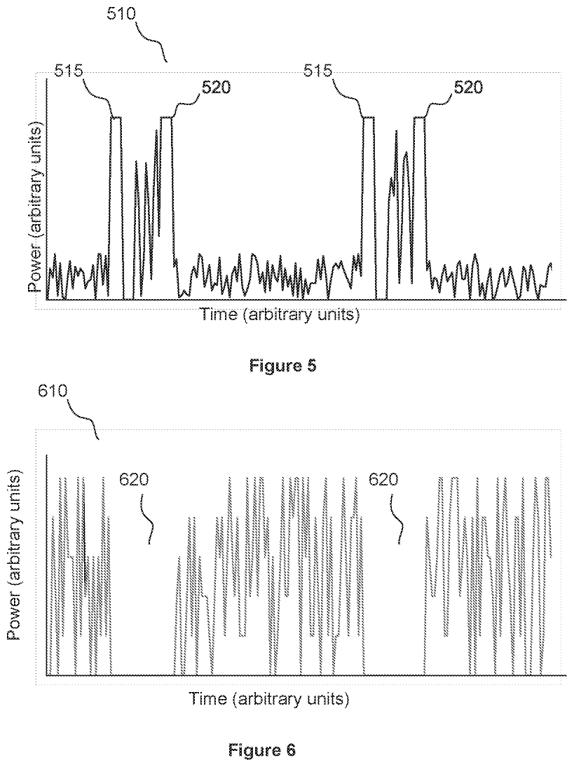

FIG. 5 illustrates an example of a power signature in a power consumption profile 510 comprising a plurality of first characteristic power spikes 515 associated with a transition from the second privilege mode to the first virtualization mode, and a plurality of second characteristic power spikes 520 associated with a transition from the first virtualization mode to the second privilege mode. The power consumption profile 510 may be a power consumption profile of a single processing core of the CPU 110, or may be an aggregate power consumption profile as described above. While the example power consumption profile 510 comprises a particular variation of power consumption with time comprising power spikes 515 and 520 having an example magnitude and duration, this is merely an illustrative example of the first characteristic power spikes 515 and the second characteristic power spikes 520, and the present disclosure is not limited such that the first characteristic power spikes 515 or the second characteristic power spikes 520 have the specific form shown in FIG. 5.

As discussed above, in order to prevent multiple conflicting accesses to a given virtualization data structure, instructions which cause access to virtualization data structures may be serialized. That is, in examples wherein the CPU 110 comprises a plurality of processing cores, execution of instructions causing access to virtualization data structures (e.g., to update or restore the said virtualization structures) may be restricted to a single processing core of the plurality. This processing core may be referred to as the processing core which is executing instructions associated with the first virtualization mode. It may be that, during access to the virtualization data structures by the said single processing core, no other instructions may be executed in the remaining cores of the of CPU 110 (e.g., the remaining cores of the CPU 110 may be quiesced or idle). Accordingly, in examples wherein the CPU 110 comprises a plurality of processing cores, transitioning from the second privilege mode to the first virtualization mode or from the first virtualization mode to the second privilege mode, may give rise to a period of characteristic reduced power consumption, at least during the said transitions, for the said plurality of processing cores excluding the processing core executing instructions associated with the first virtualization mode. The period of characteristic reduced power consumption may be detectable in the power consumption profile of the CPU 110 wherein the said power consumption profile corresponds to at least one processing core of the plurality of processing cores, wherein at least one of the at least one processing core is different to a processing core executing instructions associated with the first virtualization mode. In these examples, the said period of characteristic reduced power consumption may be characteristic (e.g. at least indicative) of the particular transition between the second privilege mode and the first virtualization mode. In these examples, a power signature associated with transitioning between the second privilege mode and the first virtualization mode may comprise the said period of characteristic reduced power consumption. In examples wherein the power consumption profile may comprise an aggregate power consumption profile, the characteristic reduced power consumption may present in the said aggregate power consumption profile. In examples wherein the power consumption profile comprises respective individual variations of power consumption with time for different cores, the characteristic reduced power consumption may be present in the variation of power consumption with time of any of the quiesced processing cores (e.g., any processing core of the plurality excluding the processing core executing instructions associated with the first virtualization mode).

FIG. 6 illustrates an example of a power signature in a power consumption profile 610 comprising a characteristic reduced power consumption comprising a plurality of periods of characteristic reduced power consumption 620 corresponding to periods where the associated processing core is quiesced (e.g., idle). The power consumption profile 610 may be a power consumption profile of a single processing core of the CPU, or may be an aggregate power consumption profile as described above. While the example power consumption profile 610 comprises a particular variation of power consumption with time comprising periods of reduced power consumption 620 having an example magnitude and duration, this is merely an illustrative example of the periods of reduced power consumption, and the present disclosure is not limited such that the said periods of reduced power consumption have the specific from shown in FIG. 6. The present disclosure is also not limited to any number of such periods of reduced power consumption.

As will be discussed further below, the security policy compliance block 130 may determine a compliance of a CPU, such as the CPU 110, for example, with a security policy depending on, at least in part, a power signature of a power consumption profile of the said CPU, wherein the power signature may be characteristic (e.g. at least indicative) of a transition, by the CPU, from a second privilege mode to a first virtualization mode, or from the first virtualization mode to the second privilege mode, in order to comply with the security policy. In some examples, the said power signature may comprise, for example, a characteristic power spike or a plurality of power spikes such as those described above. Additionally or alternatively, the said power signature may comprise, a period or a plurality of periods of characteristic reduced power consumption, such as those described above.

In some examples, the plurality of privilege modes may comprise a secure mode or a plurality of secure modes.

In some examples wherein the CPU 110 utilises an X86 architecture, the said secure mode may be a system management mode (SMM). SMM may be a special-purpose mode for handling system-wide functions including, for example, power management, and system hardware control including handling hardware interrupts. In some examples, the CPU 110 may transition into SMM depending on (e.g. responsive to) certain events, including, for example, a system management interrupt (SMI), or any other type of suitable event. In some examples, the CPU transitioning to SMM mode from another mode of the plurality of privilege modes may comprise: saving a current state of the CPU 110 corresponding to the state of the CPU 110 in a privilege mode other than SMM mode; and executing an SMI handler to execute instructions corresponding to, for example, the SMI. In examples wherein the CPU 110 comprises a plurality of processing cores, subsequent to saving the current state of the CPU, all constituent processing cores of the CPU 110 may simultaneously or substantially simultaneously enter SMM mode before a nominated or elected core of the CPU 110 executes the SMI handler.

Such a simultaneous or substantially simultaneous transition into SMM mode for each core of the plurality of processing cores may be a power intensive operation. Accordingly, in some examples, transitioning to SMM mode may give rise to a characteristic increased power consumption in a power consumption profile of the CPU 110, at least during a time period in which a transition or a plurality of transitions to SMM mode occur. The said characteristic increased power consumption may be characteristic of (e.g. at least indicative that) a transition or a plurality of transitions to SMM mode have occurred.

In some examples, a characteristic of the said characteristic increased power consumption may be that a power consumption profile having the characteristic increased power consumption comprises a greater power consumption in comparison to a corresponding power consumption profile associated with running the same or substantially identical software (e.g., as the software running on the CPU exhibiting the characteristic increased power consumption) on the same or a substantially identical CPU (e.g., the same as or identical to the CPU exhibiting the characteristic increased power consumption) wherein the said same or the said substantially identical CPU does not transition to SMM mode. The said greater power consumption may be greater in the sense that the average (e.g., mean) power consumption of the said power consumption profile having the characteristic increased power consumption is greater than an average (e.g., mean) power consumption of the said corresponding power consumption profile. Additionally or alternatively, the said greater power consumption may be greater in the sense that said power consumption profile having the characteristic increased power consumption comprises at least one peak power consumption value greater than a peak power consumption value of the said corresponding power consumption profile.

The said simultaneous or substantially simultaneous transition into SMM mode for each core of the plurality of processing cores may give rise to a characteristic power spike which is characteristic (e.g. at least indicative) of this particular transition. In some examples, the magnitude of the said characteristic power spike may be characteristic (e.g. at least indicative) of this particular transition. For example, a characteristic power spike having a magnitude lying between a predetermined upper and lower bound may be characteristic (e.g. at least indicative) of this particular transition. In some examples, the duration of the said characteristic power spike may be characteristic (e.g. at least indicative) of this particular transition. For example, a power spike having a duration lying between a predetermined upper and lower bound may be characteristic (e.g. at least indicative) of this particular transition. In some examples, the said predetermined upper and lower bounds relating to the said power spike magnitude and duration may be predetermined using any suitable means. For example, the said upper and lower bounds may be predetermined based a measurement or measurements of the said magnitude and/or duration of the said power spike. In some examples, machine learning techniques may be utilised to identify the said upper and lower bounds, or indeed, any other signature which may be characteristic of the said particular transition.

In some examples, a power signature associated with transitioning from a given privilege mode of the CPU 110 to SMM mode may comprise a characteristic power spike in a power consumption profile of the CPU. The said power spike may be similar to the characteristic power spike 515 or the characteristic power spike 520 shown in FIG. 5, for example. The said power consumption profile may comprise a variation in power consumption with time.

In some examples, the power consumption profile may comprise an aggregate power consumption profile comprising an aggregation of variations of power consumption with time of the processing cores of the said subset of the said plurality, or of the processing cores of the said plurality. In these examples, the said power spike may be present in the said aggregate power consumption profile.

Alternatively, the said power consumption profile may comprise respective individual variations of power consumption with time for each respective processing core of the said subset of the said plurality, or for each respective processing core of the said plurality. In these examples, the said power spike may be present in the variation of power consumption with time of any of the processing cores transitioning into SMM mode.

In these examples, the said power consumption profile may correspond to a power consumption associated with at least a subset of processing cores of the plurality of processing cores, said subset of processing cores comprising a plurality of processing cores.

The SMI handler may be executed by an elected or nominated processing core of the plurality of cores of the CPU 110 (where provided) and the remaining processing cores may be quiesced (e.g., idle) when the SMI handler is executed. Thus, transitioning from a given privilege mode of the CPU 110 to SMM mode may give rise to a period of reduced power consumption, at least during the said transition, for the said plurality of processing cores excluding the processing core executing instructions associated with the SMI handler. In these examples, said period of reduced power consumption may be present in the power consumption profile of the CPU 110 wherein the said power consumption profile corresponds to at least one processing core of the plurality of processing cores, wherein at least one of the at least one processing core is different to a processing core executing instructions associated with the SMM. In these examples, the said period of reduced power consumption may be characteristic of the particular transition between a given privilege mode of the CPU 110 and SMM. In these examples, a power signature associated with transitioning from the second virtualization mode to the first virtualization mode may comprise a characteristic reduced power consumption comprising the said period of reduced power consumption. Such a characteristics period of reduced power consumption may be similar to the period of reduced power consumption 620 shown in FIG. 6, for example.

In some examples, the power consumption profile may comprise an aggregate power consumption profile comprising an aggregation of a variation of power consumption with time of the respective processing cores of the said subset of the said plurality, or of the respective processing cores of the said plurality. In these examples, the said characteristic period of reduced power consumption may be present in the said aggregate power consumption profile.

Alternatively, the said power consumption profile may comprise respective individual variations of power consumption with time of each respective processing core of the said subset of the said plurality, or of each respective processing core of the said plurality. In these examples, the said characteristic period of reduced power consumption may be present in the variation of power consumption with time of any of the quiesced processing cores (e.g., any of the processing cores excluding the processing core executing instructions associated with SMM mode).

In some examples, the security policy may comprise invoking the SMM. In these examples, the SMM may be utilised to, for example, monitor the integrity of the system resources, including for example, the external system resources 120, the integrated system resources 115 or the external system resources and the integrated system resources 115. Utilising SMM mode in this manner may be referred to as an SMM integrity monitor. In these examples, the SMM may be utilised, for example, to check the integrity of kernel code memory frames of an operating system being executed by the CPU 110. In some examples, the SMM mode may be invoked intermittently or periodically in order to implement the above-described monitoring functionality, and thus to implement the security policy.

In some examples wherein the CPU 110 utilises an ARM architecture, some or all of the plurality of privilege modes may comprise secure and non-secure variants. In some examples, these variants may be referred to as “trusted” and “non-trusted” variants, respectively”. In some examples, the plurality of secure modes disclosed herein may comprise the said plurality of secure variants. For example, the plurality of modes may comprise a privilege mode EL3, which may be the most privileged mode, and may further comprise both secure and non-secure variants any one of the modes EL2-EL0. For example, the plurality of modes may comprise a non-secure-EL2 mode, a non-secure EL1 mode, and a non-secure EL0. The plurality of modes may further comprise one or a combination of: a secure EL2 mode, a secure EL1 mode, and secure EL0 mode. These secure and non-secure modes be part of an environment referred to as “Trustzone”. In some examples, transitioning from a given non-secure or non-trusted variant of a given mode of the plurality of modes to a given secure or trusted variant of a given mode of the plurality of modes may give rise to a power signature in a power consumption profile of the CPU 110 during a time period in which the said transition occurs. In these examples, the said transition may comprise first transitioning from the given non-trusted mode to, for example, a more privileged mode, such as EL3, for example, and subsequently transitioning from the said more privileged mode to the said given secure variant of the given mode. In some examples, transitioning between a given non-trusted mode and a given trusted variant of a given mode, or between a given trusted variant of a given mode of the plurality of modes and another trusted variant of another mode of the plurality of modes may give rise to a power signature in a power consumption profile of the CPU during a time period in which the said transition occurs.

For example, such transitions may be a power intensive operation, and thus, in some examples, may give rise to a characteristic increased power consumption in a power consumption profile of the CPU 110, at least during a time period in which such a transition or a plurality of such transitions occur. The said characteristic increased power consumption may be characteristic of (e.g. at least indicative that) a transition or a plurality of transitions between a given non-trusted mode of the plurality of modes and a given trusted variant of a given mode of the plurality of modes, or between a given trusted variant of a given mode of the plurality of modes and another trusted variant of another mode of the plurality of modes have occurred.

In some examples, a characteristic of the said characteristic increased power consumption may be that a power consumption profile having the characteristic increased power consumption comprises a greater power consumption in comparison to a corresponding power consumption profile associated with running the same or substantially identical software (e.g., as the software running on the CPU exhibiting the exhibiting the characteristic increased power consumption) on the same or a substantially identical CPU (e.g., the same as or identical to the CPU exhibiting the characteristic increased power consumption) wherein the said same or the said substantially identical CPU does not transition between such modes e.g., does not transition between a given non-trusted mode and a given trusted variant of a given mode, or between a given trusted variant of a given mode of the plurality of modes and another trusted variant of another mode of the plurality of modes. The said greater power consumption may be greater in the sense that the average (e.g., mean) power consumption of the said power consumption profile having the characteristic increased power consumption is greater than an average (e.g., mean) power consumption of the said corresponding power consumption profile. Additionally or alternatively, the said greater power consumption may be greater in the sense that said power consumption profile having the characteristic increased power consumption comprises at least one peak power consumption value greater than a peak power consumption value of the said corresponding power consumption profile.

In some examples, the characteristics of each of the said power signatures may depend on the particular transition which occurs. For example, the said power signatures may comprise a characteristic power spike or a plurality of characteristic power spikes which are characteristic (e.g. at least indicative) of any of the above-discussed transitions relating to an ARM architecture. The said characteristic power spike or plurality of characteristic power spikes may be similar to those shown in FIG. 5, for example. In some examples, the said characteristic power spike may or plurality of characteristic power spikes may have a duration lying between a predetermined upper and lower bound, wherein the said duration may be characteristic (e.g. at least indicative) of any of the above-discussed transitions relating to an ARM architecture. In some examples, the said power signatures may comprise a characteristic reduced power consumption comprising a period or periods of reduced power consumption for at least one core of the CPU 110 which may have been quiesced during any of the above-discussed transitions relating to an ARM architecture, similar to the characteristic reduced power consumption shown in FIG. 6, for example.

In any example disclosed herein, the disclosed characteristic reduced power consumption may be characteristic (e.g. at least indicative) of any of the corresponding mode transitions disclosed herein. For example, the said characteristic reduced power consumption may have a period or periods of reduced power consumption having a duration lying between a predetermined upper and lower bound, wherein the said duration may be characteristic (e.g. at least indicative) of any of the corresponding mode transitions disclosed herein. In some examples, the relative change in power consumption during the said period or periods of reduced power consumption may have a relative magnitude lying between a predetermined upper and lower bound, wherein the said relative magnitude may be characteristic (e.g. at least indicative) of any of the corresponding mode transitions disclosed herein.

In some examples, the said predetermined upper and lower bounds relating to the first characteristic power spike magnitude and duration may be predetermined using any suitable means. For example, the said upper and lower bounds may be predetermined based on a previous measurement or previous measurements of the said magnitude, duration or magnitude and duration of the said power spike or plurality of power spikes, and/or of the said period or periods of reduced power consumption. In some examples, machine learning techniques may be utilised to identify the said upper and lower bounds, or indeed, any other signature which may be characteristic (e.g. at least indicative) of any of the above-discussed transitions relating to an ARM architecture.

Referring back to FIG. 1, the power source 140 of the computing system 100 may comprise a voltage regulator or a plurality of voltage regulators. The said voltage regulator or plurality of voltage regulators may be, for example, buck converters, or any other suitable type of voltage regulator. The said voltage regulator or plurality of voltage regulators may be configured to provide a target voltage or voltages to a domain or a plurality of domains of the CPU 110. The CPU 110 may comprise a plurality of processing cores. The power source 110 may comprise a plurality of voltage regulators. The plurality of voltage regulators may be configured to provide a target voltage to the said plurality of respective processing cores of the CPU 110. In some examples, the said voltage regulator or plurality of voltage regulators may be configured to receive data specifying a respective target output voltage or voltages for each of the said regulators to provide to the respective processing cores, for example from power management circuitry of or associated with the CPU 110.

In some examples, the computing system 100 may employ dynamic frequency scaling or dynamic frequency and voltage scaling wherein the frequency and/or voltage of the processing core or cores are adapted depending on a corresponding work load or anticipated work load.

In some examples, the computing system 100 may comprise a security policy compliance block 130. The security policy compliance block 130 may be implemented in hardware, software, firmware, or any combination thereof. In some examples the said hardware may be processing circuitry for example. In these examples, the processing circuitry be part of the CPU 110, or may be any other processing circuitry.

In some examples, the security compliance block 130 may determine whether a CPU, such as the CPU 110, for example, is compliant with a security policy during a first time period. The security policy may comprise any security policy or any combination of security policies disclosed herein. Accordingly, complying with the security policy may give rise to a power signature in a power consumption profile of the CPU during the first time period. The said power signature may be characteristic (e.g. at least indicative) of the CPU being compliant with the security policy. In some examples, the CPU being compliant with the security policy during the first time period comprises the CPU transitioning between a lower privilege mode and a greater privilege mode during the first time period.

In some examples, for the purposes of determining if the CPU is compliant with the security policy, the CPU may be caused to execute or run a predefined workload or a plurality of predefined workloads which may give rise to a known power signature in a power consumption profile of the CPU during a period of compliance with the security policy. As used herein, a workload refers to a software operation or a plurality of software operations. Such a software operation or operations, may include, for example, a browser application opening a given web page, or a word processing application opening a given word document, or any other suitable software operation. In these examples, the known power signature may comprise any of the power signatures disclosed herein, including, for example: a characteristic increased power consumption; a characteristic power spike or a plurality of characteristic power spikes; a characteristic reduced power consumption; or any combination thereof.

For example, the security policy may comprise executing, by the processing unit, at least one operating system in a virtual machine as disclosed hereinbefore, and executing or running the said predefined workload or plurality of predefined workloads by the CPU 110 in accordance with this security policy may give rise to a power signature comprising, for any of the reasons already disclosed herein, any of: a characteristic increased power consumption; a characteristic power spike or a plurality of characteristic power spikes; a characteristic reduced power consumption; or any combination thereof. In examples wherein the power signature comprises a characteristic power spike or a plurality of characteristic power spikes, or a characteristic reduced power consumption, the said predefined workload or predefined workloads may cause any of the disclosed mode transitions of the CPU which give rise to these signatures. Additionally or alternatively, the security policy may comprise invoking a secure mode or a plurality of secure modes of the CPU as disclosed hereinbefore, and executing the said predefined workload or plurality of predefined workloads may cause the said secure mode or at least one secure mode of the said plurality of secure modes to be invoked, which, for any of the reasons already disclosed herein, may give rise to a power signature comprising any of: a characteristic increased power consumption; a characteristic power spike or a plurality of characteristic power spikes; a characteristic reduced power consumption; or any combination thereof.

As already discussed, a characteristic increased power consumption disclosed herein may comprise a greater power consumption (e.g., a greater average (e.g., mean) power consumption and/or at least one greater peak power consumption value) of a power consumption profile in comparison to a corresponding power consumption profile of a non-compliant but otherwise similar or substantially identical CPU. In examples wherein running or executing the said predefined workload or plurality of predefined workloads in compliance with the security policy give rise to a power signature comprising a characteristic increased power consumption, the characteristic increased power consumption may have a known average (e.g., mean) power consumption and/or a known peak power consumption during a period when the said predefined workload or plurality of workloads are executed by a CPU which is compliant with the security policy. Accordingly, causing execution of the said predefined workload or plurality of predefined workloads may enable the characteristic increased power consumption to be attributed to compliance with the security policy and distinguished from other causes of increased power consumption.

In some examples, the CPU may be caused to execute or run the said predefined workload or plurality of predefined workloads by any of software, hardware, firmware, or any combination thereof. In some examples, the security policy compliance block 130 may cause the CPU to execute or run the said predefined workload or workloads.

In some examples, the said transition between a lower privilege mode and a greater privilege mode may be caused or invoke for any of the reasons disclosed herein. Additionally or alternatively, the said transition between a lower privilege mode and a greater privilege mode may be triggered (e.g., caused or invoked) by an external interrupt. In these examples, the external interrupt may be caused by external hardware which is external to the CPU 110. In these examples, the external interrupt may serve to cause the said transition for the purposes of determining if the CPU 110 is compliant with the security policy. In some examples, the said external hardware may comprise or be operably coupled to an Advanced Programmable Interrupt controller of the computing system 100. In some examples, the said external hardware may be part of the system block 130, or may comprise other circuitry, such as processing circuitry, for example.

In some examples, the power signature may be characteristic (e.g. at least indicative) of a privilege mode or level, or of a plurality of privilege modes or levels during the first time period. In some examples, the CPU being compliant with the security policy may comprise the CPU having a particular privilege level or a plurality of privilege levels during a period of compliance with the security policy. The security compliance block 130 may determine whether the said CPU is compliant with the said security policy, depending, at least in part, on obtained first data indicative of a power consumption profile of the said CPU during a first time period. In some examples, the security compliance block may determine a lack of compliance of the CPU with the security policy and may cause a mitigating action depending on this determination.

In some examples, the security compliance block 130 may obtain first data indicative of a power consumption profile of the CPU 110 for a first time period. The power consumption profile may comprise a variation of power consumption with time. In examples wherein the CPU 110 comprises a single processing core, the said power consumption profile may correspond to a power consumption associated with the single processing core of the CPU 110. In these examples, the said power consumption profile corresponding to a power consumption associated with the single processing core of the CPU 110 may comprise any of the power signatures disclosed herein, including, for example: a characteristic increased power consumption; a characteristic power spike or a plurality of characteristic power spikes; or any combination thereof. In examples wherein the CPU 110 comprises a plurality of processing cores, the said power consumption profile may correspond to a power consumption associated with any one of: a single processing core of the said plurality; each processing core of the said plurality; a subset of processing cores of the said plurality, the said subset comprising a plurality of processing cores. In these examples, the said power consumption profile may comprise any of the power signatures disclosed herein, including, for example any of: a characteristic increased power consumption; a characteristic power spike or a plurality of characteristic power spikes; a characteristic reduced power consumption; or any combination thereof. As disclosed herein, the power consumption profile may comprise an aggregate power consumption profile or respective individual variations of power consumption with time of each respective processing core of the said subset of the said plurality, or of each respective processing core of the said plurality. In these examples, the power signature may be may be present in either the said aggregate power consumption profile or the said power consumption profile comprising a plurality of respective variations of power consumption with time in accordance with any example disclosed herein.

In some examples, the said obtained first data may comprise data indicative of any of: a voltage of at least one core of the CPU 110 during the first time period; a current drawn by the at least one core of the CPU 110 during the first time period; a frequency of at least one core of the CPU 110 during the first time period; an intensity of electromagnetic radiation emitted by the CPU 110 during the first time period; combinations thereof.

In some examples, obtaining data indicative of a voltage of at least one core of the CPU 110 may comprise any of: measuring a voltage of the at least one core of the CPU 110 during the first time period; monitoring, during the first time period, a target voltage of at least one voltage regulator operatively coupled to the at least one core of the CPU; receiving data indicative of a voltage of at the least one core of the CPU during the first time period.

In examples wherein obtaining data indicative of a voltage of at least one core of the CPU 110 comprises measuring a voltage of the at least one core of the CPU, the said voltage may be measured using any suitable technique. For example, the said voltage may be measured by way of voltage sensing circuitry which may be, for example, integrated within the power source 140, otherwise part of the computing system 100, or included in circuitry associated with the security policy compliance block.

In examples wherein obtaining data indicative of a voltage of at least one core of the CPU 110 comprises monitoring, during the first time period, a target voltage of at least one voltage regulator operatively coupled to the at least one core of the CPU, the said data may be obtained by, for example, monitoring a voltage demanded by the at least one processing core from the at least one voltage regulator. In these examples, the said voltage demand may be monitored by circuitry associated with the security policy compliance block 130, or by any other circuitry.

In examples wherein obtaining data indicative of a voltage of at least one core of the CPU 130 comprises receiving data indicative of a voltage of at the least one core of the CPU during the first time period, the said data may be received from, for example: a memory, the said data having been stored in memory, by for example, power management circuitry configured to track and store the said voltage of the said at least one core, or by any other circuitry. In other examples, the said data may be received directly from, for example, power management circuitry or any other circuitry configured to track and store the said voltage of the said at least one core.

In some examples, obtaining data indicative of a current drawn by at least one core of the CPU 110 may comprise any of: measuring a current drawn by the at least one core of the CPU 110 during the first time period; receiving data indicative of a current drawn by the at least one core of the CPU during the first time period.

In examples wherein obtaining data indicative of a current drawn by at least one core of the CPU 110 comprises measuring a current drawn by the at least one core of the CPU during the first time period, the said current may be measured using any suitable technique. For example, the said current may be measured by way of current sensing circuitry which may be, for example, be integrated within the power source 140, otherwise part of the computing system 100, or included in circuitry associated with the security policy compliance block.

In examples wherein obtaining data indicative of a current drawn by at least one core of the CPU 110 comprises receiving data indicative of a current drawn by the at least one core of the CPU during the first time period, the said data may be received from, for example: memory, the said data having been stored in memory, by for example, power management circuitry, or any other circuitry configured to track and store the said current drawn by the said at least one core. In other examples, the said data may be received directly from, for example, power management circuitry or any other circuitry configured to track and the said current drawn by the said at least one core.

In some examples, obtaining data indicative of a frequency of at least one core of the CPU 110 during the first time period may comprise any one of: measuring a frequency of the at least one core of the CPU 110; monitoring a target frequency set by power management circuitry operatively coupled to the at least one core of the CPU 110; receiving data indicative of the frequency of the at least one core of the CPU 110.

In examples wherein obtaining data indicative of a frequency of at least one core of the CPU 110 during the first time period comprises measuring a frequency of the at least one core, the said frequency may be measured using any suitable technique.

In examples wherein obtaining data indicative of a frequency of at least one core of the CPU 110 during the first time period comprises monitoring a target frequency set by power managing circuitry operatively coupled to the at least one core of the CPU 110.

In examples wherein obtaining data indicative of a frequency of at least one core of the CPU 110 during the first time period comprises receiving data indicative of the frequency of the at least one core, the said data may be received from, for example: memory, the said data having been stored in memory, by for example, power management circuitry, or any other circuitry configured to track and store the said frequency of the at least one core. In other examples, the said data may be received directly from, for example, power management circuitry or any other circuitry configured to track the said frequency of the at least one core.

In some examples, obtaining data indicative of an intensity of electromagnetic radiation emitted by the CPU 110 during the first time period may comprise any one of: measuring an intensity of electromagnetic radiation emitted by the CPU during the first time period; receiving data indicative of an intensity of electromagnetic radiation emitted by the CPU during the first time period.

In examples wherein obtaining data indicative of an intensity of an electromagnetic radiation emitted by the CPU during the first time period comprises measuring an intensity of electromagnetic radiation emitted by the CPU during the first time period, the said intensity may be measured using any suitable technique. For example, the said intensity may be measured by way of electromagnetic sensing circuitry which may be, for example, integrated within the power source 140, otherwise part of the computing system 100, or included in circuitry associated with the security policy compliance block.

In examples wherein obtaining data indicative of an intensity of an electromagnetic radiation emitted by the CPU during the first time period comprises receiving the said data, the said data may be received from, for example: memory, the said data having been stored in memory, by for example, power management circuitry, or any other circuitry configured to track and store the intensity of electromagnetic radiation emitted by the CPU. In other examples, the said data may be received directly from, for example, power management circuitry or any other circuitry configured to measure the intensity of electromagnetic radiation emitted by the CPU.

It may be that some of the above-discussed parameters (e.g., current, voltage, frequency, or intensity of electromagnetic radiation) relating to the data indicative of a power consumption profile of the CPU are indicative of a power consumption profile of the CPU based on assumptions relating to the operation of the CPU. For example, in examples wherein the obtained first data comprises data indicative of a current drawn by at least one processing core of the CPU, it may be assumed a corresponding voltage of the at least one processing core is constant during this time, and thus, it may be assumed that the data indicative of the said current is indicative of the power consumption profile of the said at least one core. While, in this example, the voltage of the at least one core may change during the said time, the assumption that it does not is sufficient for the purposes of determining a compliance with a security policy in accordance with the present disclosure in at least some examples. Similar assumptions are also sufficient regarding other parameters discussed above (e.g., voltage frequency, and intensity of electromagnetic radiation) in at least some examples.

In some examples, the security compliance block 130 may be configured to determine whether the CPU 130 is compliant with the security policy depending, at least in part, on the obtained first data. In some examples, the said determination may comprise determining whether the power consumption profile comprises the power signature. In some examples, determining if the power consumption profile comprises the power signature may comprise, determining, depending, at least in part, on the obtained first data, whether the power consumption profile comprises a known power signature characteristic of compliance with the security policy. For example, the security compliance block may obtain data indicative of a power signature or signatures which are indicative of compliance, by the CPU, with a current security policy or polices, and compare the obtained first data with the said data indicative of said signature or signatures to determine if the power consumption profile comprises obtained the said signature or signatures. In examples wherein the CPU is caused to run or execute a (e.g. predefined) workload or a plurality of (e.g. predefined) workloads, the known power signature may depend on the particular workload or plurality of workloads having been executed or run.

In some examples, the security compliance block 130 may obtain the said power signature or power signatures by receiving the said power signature or power signatures. For example the security compliance block 130 may receive the said power signature or power signatures from a memory to which it is operatively coupled. In some examples, the said memory may be memory included in the system resources 115. In other examples, the said memory may be memory included in the system resources 120. In yet other examples, the said memory may be otherwise included in the computer system 100.

As discussed previously, the known power signatures may have been predetermined empirically from a measurement or measurements of a power consumption profile or power consumption profiles comprising the said power signatures. As disclosed herein, said predetermined power signatures may have been predetermined for example, using machine learning techniques, or any other suitable techniques. I

In some examples, the security policy or policies may be one or any combination of the security policies disclosed herein. For example, the security policy may comprise executing, by the CPU, at least one operating system in a virtual machine. Additionally or alternatively, the security policy may comprise invoking a secure mode, such as system management mode.

In some examples wherein the security policy comprises executing, by the CPU, at least one operating system in a virtual machine, the virtual machine may be implemented utilising a type 2 hypervisor and the associated characteristic power signature may be a characteristic increased power consumption, as disclosed herein. In other examples wherein the security policy comprises executing, by the CPU, at least one operating system in a virtual machine, the virtual machine may be implemented utilising a type 1 hypervisor. In these examples, the associated characteristic power signature may comprise a characteristic power spike or a plurality of characteristic power spikes. In examples wherein the CPU 110 comprises a plurality of processing cores, the said associated characteristic power signature may comprise, additionally or alternatively to the said power spike or plurality of power spikes, a characteristic reduced power consumption, as disclosed herein.

In examples wherein the security policy comprises invoking a system management mode, the associated characteristic power signature may comprise a characteristic power spike or a plurality of characteristic power spikes. In examples wherein the CPU 110 comprises a plurality of processing cores, the said associated characteristic power signature may comprise, additionally or alternatively to the said power spike or plurality of power spikes, a characteristic reduced power consumption, as disclosed herein.

In some examples, the security compliance block 130 may determine a lack of compliance of the CPU with the security policy. For example, the security compliance block 130 may determine a lack of compliance of the CPU with the security policy if the security compliance block 130 determines that the obtained first data indicative does not comprise the power signature. Having determined a lack of compliance of the CPU with the security policy, the security policy compliance block may cause a mitigating action depending on the determination of the lack of compliance with the security policy. In some examples, the mitigating action may comprise generating a notification of the lack of compliance with the security policy. For example, the security compliance block 130 may generate a notification to a user of the computing system 100, by, for example, causing a notification to be displayed on a display which is operatively coupled to the computing system 100. Additionally or alternatively, the security compliance block 130 may generate a notification to a management system, such as an information technology (IT) management system, for example, to which it may be communicatively coupled. The said management system may form part of the computer system 100 or may be external to the computing system. In some examples, the mitigating action may comprise disabling hardware associated with the CPU 110. For example, the mitigating action may comprise disabling hardware components associated with CPU 110 which provide network connectivity to the computer system 100. For example, such hardware components may include, WiFi or ethernet card, or any other hardware which may provide network connectivity to the computing system 100. In some examples, the mitigating action may comprise rebooting the computer system 100. In some examples, subsequent to have rebooted the computing system 100, the security compliance block may obtain second data indicative of a power consumption profile of the CPU 110 during a second time period, and determine compliance of the CPU with the security policy during the second time period depending, at least in part, on the obtained second data. The said obtained second data may be obtained in the same or substantially the same manner as the obtained first data. The determination of compliance of the CPU with the security policy during the second time period, depending, at least in part, on the obtained second data may be determined in the same or a substantially similar manner as the determination of compliance of the CPU with the security policy depending, at least in part, on the obtained first data. In some examples, the mitigating action may comprise shutting down the computing system 100. In some examples, the mitigating action may comprise any combination of the mitigating actions disclosed herein.

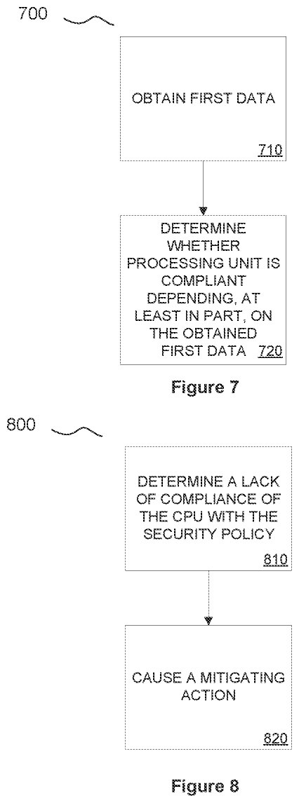

FIG. 7 depicts a flow chart 700 according to an example implementation for determining a compliance with a security a policy in a computing system, wherein the computing system has a central processing unit. The computing system may correspond to the computing system 100. In these examples, the CPU referred to may be the CPU 110. In other examples, the said computing system may correspond to any other suitable computing system. Flow chart 700 may be performed by the security compliance block 130 but it will be understood that any suitable processing circuitry may alternatively perform flow chart 700.

At block 710, first data indicative of a power consumption profile of a CPU, such as the CPU 110, for example, for a first time period is obtained. The power consumption profile may comprise a variation of power consumption with time. In examples wherein the CPU comprises a single processing core, the said first data may comprise data indicative of a power consumption profile of the said single processing core In examples wherein the CPU comprises a plurality of processing cores, the said first data may comprise data indicative of a power consumption profile for any of: a single processing core of the said plurality; each processing core of the said plurality; a subset processing cores of the said plurality, the said subset comprising a plurality of processing cores.

The said first data may be obtained in accordance with any example disclosed herein. For example, obtaining the first data may comprise obtaining data indicative of any of: a voltage of at least one core of the CPU during the first time period; a current drawn by at least one core of the CPU during the first time period; a frequency of at least one core of the CPU during the first time period; an intensity of electromagnetic radiation emitted by the CPU during the first time period; or any combination thereof. The said data indicative of any of the said voltage, the said current, the said frequency, and the said intensity of electromagnetic radiation may be obtained in accordance with any example disclosed herein. For example, any of the said data may be measured, received, or obtained in any other manner as disclosed herein. At block 720, it is determined whether the CPU is compliant with the security policy depending, at least in part, on the obtained first data. The compliance with the security policy may be determined according to any of the examples disclosed herein. For example, it may be determined whether the CPU is compliant with the security policy by determining if the power consumption profile comprises a power signature. In some examples, determining if the obtained first data comprises the power signature may comprise comparing the obtained first data with data indicative of a known power signature characteristic of compliance with the security policy, as disclosed herein. For example, a power signature or signatures which are characteristic of indicative of compliance, by the CPU, with a security policy or polices, may be obtained and compared to the obtained first data with the said data indicative of a signature or signatures to determine if the power consumption profile comprises the said signature or signatures. The said power signature or power signatures may be obtained in accordance with any examples disclosed herein. For example, the said power signature or power signatures may be received from a memory.

FIG. 8 depicts a flow chart 800 according to an example implementation for causing a mitigating action depending on a determination of a lack of compliance of a CPU with a security policy. Flow chart 800 may be implemented in a computing system, such as the computing system 100, for example. In these examples, the CPU referred to may be the CPU 110. In other examples, the said computing system may correspond to any other suitable computing system. Flow chart 800 may be performed by the security compliance block 130 but it will be understood that any suitable processing circuitry may alternatively perform flow chart 800. In some examples, the flow chart 800 may be implemented subsequent to having implemented the flow chart 700.

At block 810, it may be determined if there is a lack of compliance of a CPU with a security policy. The said determination may occur, for example, at block 720 of the flowchart 700. In some examples, a lack of compliance of the CPU with the security policy may be determined by determining the obtained first data indicative of a power consumption profile of the CPU does not comprise the power signature.

At block 820, a mitigating action may be caused depending on the determination at block 810. For example, any mitigating action disclosed herein may be performed depending on the determination at block 810. In some examples, the mitigating action may comprise generating a notification of the lack of compliance with the security policy. For example, a notification to a user of the computing system 100 may be generated, by, for example, causing a notification to be displayed on a display which is operatively coupled to the computing system 100. Additionally or alternatively, a notification may to a management system, such as an information technology (IT) management system, for example, to which it may be communicatively coupled may be generated. The said management system may form part of the computer system 100 or may be external to the computing system. In some examples, the mitigating action may comprise disabling hardware associated with the CPU 110. For example, the mitigating action may comprise disabling hardware components associated with CPU 110 which provide network connectivity to the computer system 100. For example, such hardware components may include, Wi-Fi or ethernet card, or any other hardware which may provide network connectivity to the computing system 100. In some examples, the mitigating action may comprise rebooting the computer system 100. In some examples, subsequent to have rebooted the computing system 100, the security compliance block may obtain second data indicative of a power consumption profile of the CPU 110 during a second time period, and determine whether the CPU is compliant with the security policy during the second time period depending, at least in part, on the obtained second data. The said obtained second data may be obtained in the same or substantially the same manner as the obtained first data. The determination of compliance of the CPU with the security policy during the second time period, depending, at least in part, on the obtained second data may be determined in the same or a substantially similar manner as the determination of compliance of the CPU with the security policy depending, at least in part, on the obtained first data. In some examples, the mitigating action may comprise shutting down the computing system 100. In some examples, the mitigating action may comprise any combination of the mitigating actions disclosed herein.

In this specification, the phrase “at least one of A or B” and the phrase “at least one of A and B” should be interpreted to mean any one or more of the plurality of listed items A, B, etc., taken jointly and severally in any and all permutations.

Where functional units are described as circuitry, such as the security compliance block 130, for example, the circuitry may be general purpose processor circuitry configured by program code to perform specified processing functions. In some examples, the circuitry may be the CPU 110, such as, for example, a single core or a plurality of cores of the CPU 110. The circuitry may also be configured by modification to the processing hardware. The configuration of the circuitry to perform a specified function may be limited exclusively to hardware, limited exclusively to software, or a combination of hardware modification and software execution. Program instructions may be used to configure the logic gates of general purpose or special purpose processor circuitry to perform a processing function.

Circuitry may be implemented, for example, as a hardware circuit comprising processors, microprocessors, circuits, circuit elements (e.g., transistors, resistors, capacitors, inductors, and so forth), integrated circuits, application specific integrated circuits, programmable logic devices, digital signal processors, field programmable gate arrays, logic gates, registers, semiconductor devices, chips, microchips, chip sets, and the like.

The processors may comprise general purpose processors, network processors that process data communicated over a computer network, or other types of processor, including reduced instruction set computers or complex instruction set computers. Each processor may have a single or a multiple core design. Multiple core processors may integrate different processor core types on the same integrated circuit die.

The security compliance block 130 described herein may be implemented in whole or in part by machine-readable program instructions. Machine-readable program instructions may be provided on a transitory medium, such as a transmission medium, or on a non-transitory medium, such as a storage medium. These machine-readable instructions (computer program code) may be implemented in a high level procedural or object oriented programming language. However, the program(s) may be implemented in assembly or machine language, if desired. In any case, the language may be a compiled or interpreted language, and combined with hardware implementations.

Examples of the present disclosure are applicable for use with all types of semiconductor integrated circuit (IC) chips. Examples of these IC chips include but are not limited to processors, controllers, chipset components, programmable logic arrays, memory chips, and network chips. One or more of the components described herein may be embodied as a System On Chip (SOC) device. A SOC may include, for example, one or more Central Processing Unit cores, one or more Graphics Processing Unit cores, an Input/Output interface, and a memory controller. In some examples, a SOC and its components may be provided on one or more integrated circuit die; for example, they may be packaged into a single semiconductor device.

The disclosure also extends to the following examples.

Example 1: A (e.g., computer implemented) method of determining whether a processing unit is compliant with a security policy, the method comprising: obtaining first data indicative of a power consumption profile of the processing unit for a first time period, the power consumption profile comprising a variation of power consumption with time; and determining whether the processing unit is compliant with the security policy during the first time period depending, at least in part, on the obtained first data, wherein the processing unit complying with the security policy gives rise to a power signature in the power consumption profile of the processing unit during a period of compliance.

Example 2: The method of Example 1, wherein determining whether the processing unit is compliant with the security policy depending, at least in part, on the obtained first data comprises determining, depending at least in part on the obtained first data, whether the power consumption profile comprises the power signature.

Example 3: The method of any one preceding example, wherein determining whether the power consumption profile comprises the power signature depends on the obtained first data and data indicative of a known power signature characteristic of compliance with the security policy.

Example 4: The method of any one preceding example further comprising determining that the processing unit is compliant with the security policy depending at least in part on the obtained first data.

Example 5: The method of any one preceding example further comprising determining that the processing unit is compliant with the security policy depending at least in part on the obtained first data being indicative that the power consumption profile comprises the power signature.

Example 6: The method of any one preceding example, further comprising determining a lack of compliance of the processing unit with the security policy depending at least in part on the obtained first data (e.g. depending on the obtained first data indicating that the power consumption profile does not comprise the power signature) and causing a mitigating action depending on the determination of the lack of compliance of the processing unit with the security policy.

Example 7: The method of Example 6, wherein the mitigating action comprises any one of: generating a notification of the lack of compliance with the security policy; disabling hardware associated with the processing unit; shutting down the processing unit; rebooting a computing system associated with the processing unit; or any combination thereof.

Example 8: The method of any one preceding example, wherein the processing unit is operable in each of a plurality of modes, each of said modes having a corresponding privilege level giving the processing unit respective selected access rights to system resources in that mode.

Example 9: The method of Example 8, wherein the processing unit being compliant with the security policy comprises the processing unit transitioning between a lower privilege mode and a greater privilege mode.

Example 10: The method of Example 9, further comprising an external trigger causing the processing unit to transition between the lower privilege mode and the greater privilege mode.

Example 11: The method of Example 10, wherein the external trigger is received by the processing unit from hardware external to the processing unit.

Example 12: The method of any one preceding example, wherein at least part of the power signature is indicative of the processing unit transitioning between a lower privilege mode and a greater privilege mode.

Example 13: The method of any one preceding example, wherein the power signature depends on a mode of the processing unit to be invoked to comply with the security policy.

Example 14: The method of any one preceding example, wherein the power consumption profile is indicative of a privilege level or a plurality of privilege levels of the processing unit during the first time period.

Example 15: The method of any one preceding example, wherein the processing unit complying with the security policy comprises the processing unit having a security policy compliant privilege level or a plurality of security policy compliant privilege levels during a period of compliance with the security policy.

Example 16: The method of any one preceding example, wherein the security policy comprises executing, by the processing unit, at least one operating system in a virtual machine.

Example 17: The method of Example 16, wherein the virtual machine is implemented utilising a hypervisor.

Example 18: The method of Example 17, wherein the hypervisor is a type 2 hypervisor.

Example 19: The method of any one preceding example, wherein the power signature comprises a characteristic increased power consumption during a period of compliance of the processing unit with the security policy.

Example 20: The method of any one preceding example, wherein the power signature comprises a characteristic reduced power consumption during a period of compliance of the processing unit with the security policy.

Example 21: The method of any one Examples 6-20, wherein the plurality of modes comprises a first virtualization mode and a second privilege mode, the first virtualization mode having a greater privilege level than the second privilege mode, and wherein the security policy comprises utilising the first virtualization mode to execute, by the processing unit, an operating system in a virtual machine utilising a hypervisor (such as e.g., a type 1 or type 1.5 hypervisor, or any other type of hypervisor which may utilise the first virtualization mode including a type 2 hypervisor).

Example 22: The method of any one preceding example, wherein the power signature comprises any one of: a characteristic increased power consumption during a period of compliance of the processing unit with the security policy; a characteristic power spike or a plurality of characteristic power spikes during a period of compliance of the processing unit with the security policy; or any combination thereof.

Example 23: The method of any one preceding example, wherein the power signature comprises a characteristic reduced power consumption for at least one processing core of the processing unit during a period of compliance of the processing unit with the security policy.

Example 24: The method of any one preceding example, wherein the characteristic reduced power consumption comprises a period or a plurality of periods of reduced power consumption.

Example 25: The method of any one of Examples 23 to 24, wherein at least one of the at least one processing core is a processing core of the processing unit other than a processing core of the processing unit executing instructions associated with the first virtualization mode (e.g., wherein at least one of the at least one processing core is a core that has been quiesced e.g., as a result of the processing unit complying with the security policy).

Example 26: The method of any one preceding example, wherein the processing unit comprises a plurality of processing cores, and wherein the power consumption profile corresponds to a power consumption associated with any of: a single processing core of the plurality of processing cores; each processing core of the plurality of processing cores; each processing core of a subset of processing cores of the plurality of processing cores, the subset of processing cores comprising a plurality of cores.

Example 27: The method of Example 26, wherein the power consumption profile comprises either: an aggregate power consumption profile comprising an aggregation of a variation of power consumption with time of the processing cores of the said subset of the said plurality, or of the respective processing cores of the said plurality; or individual respective variations of power consumption with time of the respective processing cores of the said subset of the said plurality, or of the said plurality.

Example 28: The method of any one preceding example, wherein the plurality of modes comprises a secure mode or a plurality of secure modes, and wherein the security policy comprises invoking the secure mode or the plurality of secure modes.

Example 29: The method of Example 28, wherein the processing unit complying with the security policy comprises periodically or intermittently invoking the secure mode or the plurality of secure modes.

Example 30: The method of any of Examples 28-29, wherein, the secure mode is a system management mode.

Example 31: The method of any one of Examples 28-29, wherein the plurality of secure modes comprises a plurality of secure variants of respective non-secure modes.

Example 32: The method of any of Examples 28-31, wherein the power signature comprises a characteristic increased power consumption during a period of compliance of the processing unit with the security policy.

Example 33: The method of any one of Examples 28-32, wherein the power signature comprises a characteristic reduced power consumption for at least one processing core of the processing unit during a period of compliance of the processing unit with the security policy.

Example 34: The method of any one preceding example, wherein the characteristic reduced power consumption comprises a period or a plurality of periods of reduced power consumption.

Example 35: The method of any one of Examples 28 to 34, wherein at least one of the at least one processing core is a core that has been quiesced e.g., as a result of the processing unit complying with the security policy.

Example 36: The method of any one of Examples 28 to 35, wherein at least one of the at least one processing core is a core of the processing unit other than a processing core of the processing unit executing instructions associated with the system management mode (e.g., wherein at least one of the at least one processing core is a core that has been quiesced e.g., as a result of the processing unit complying with the security policy).

Example 37: The method of any one of Examples 28 to 36, wherein the power signature comprises: a characteristic power spike or a plurality of characteristic power spikes during a period of compliance of the processing unit with the security policy, said power spike or spikes corresponding to invoking the secure mode or the plurality of secure modes.

Example 38: The method of any one preceding example, wherein the processing unit comprises a plurality of processing cores, and wherein the power consumption profile corresponds to a power consumption associated with any of: a single processing core of the plurality of processing cores; each processing core of the plurality of processing cores; each processing core of a subset of processing cores of the plurality of processing cores, the subset of processing cores comprising a plurality of cores.

Example 39: The method of Example 38, wherein the power consumption profile comprises either: an aggregate power consumption profile comprising an aggregation of a variation of power consumption with time of the processing cores of the said subset of the said plurality, or of the respective processing cores of the said plurality; or individual respective variations of power consumption with time of the respective processing cores of the said subset of the said plurality, or of the said plurality.

Example 40: The method of any one preceding Example, wherein obtaining the first data comprises obtaining data indicative of any of: a voltage of at least one core of the processing unit during the first time period; a current drawn by at least one core of the processing unit during the first time period; a frequency of at least one core of the processing unit during the first time period; an intensity of electromagnetic radiation emitted by the processing unit during the first time period; or any combination thereof.

Example 41: The method of Example 40, wherein obtaining data indicative of a voltage of at least one core of the processing unit during the first time period comprises any one of: measuring a voltage of the at least one core of the processing unit during the first time period; monitoring, during the first time period, data indicative of a target voltage of at least one voltage regulator operatively coupled to the at least one core of the processing unit; receiving data indicative of a voltage of at the least one core of the processing unit during the first time period.

Example 42: The method of Example 40, wherein obtaining data indicative of a current drawn by the processing unit during the first time period comprises any one of: measuring a current drawn by the at least one core of the processing unit during the first time period; receiving data indicative of a current drawn by the at least one core of the processing unit during the first time period.

Example 43: The method of Example 40, wherein obtaining data indicative of a frequency of at least one core of the processing unit comprises any one of: measuring a frequency of the at least one core of the processing unit; monitoring a target frequency of the at least one core of the processing unit; receiving data indicative of the frequency of the at least one core of the processing unit.

Example 44: The method of Example 40, wherein obtaining data indicative of an intensity of electromagnetic radiation emitted by the processing unit during the first time period comprises any one of: measuring an intensity of electromagnetic radiation emitted by the processing unit during the first time period; receiving data indicative of an intensity of electromagnetic radiation emitted by the processing unit during the first time period.

Example 45: The method of any one preceding Example, wherein the processing unit is caused to execute or run a predefined workload or a plurality of predefined workloads.

Example 46: The method of any one preceding Example, wherein the processing unit is caused to execute or run the predefined workload or the plurality of predefined workloads during the first time period.

Example 47: The method of any one of Examples 45 to 46, wherein the predefined workloads or the plurality of predefined workloads give rise to a known power signature in the power consumption profile of the processing unit during a period of compliance with the security policy.

Example 48: The method of any one of Examples 45 to 47, wherein the known power signature depends on the predefined workloads or the plurality of predefined workloads.

Example 49: The method of any one of Examples 45 to 48, comprising an (e.g., software) exerciser causing the processing unit to execute or run the predefined workload or the plurality of predefined workloads.

Example 50: Apparatus comprising processing circuitry to perform the method of any one preceding Example.

Example 51: Apparatus comprising processing circuitry to: obtain data indicative of a variation of power consumption with time, the data relating to at least one processing core of a processing unit; and determine whether the processing unit is compliant with a security policy depending, at least on part, on whether the obtained data is indicative of a power signature associated with a period of compliance with the security policy.

Example 52: The apparatus according to Example 51, further comprising a memory storing instructions executable by the processing circuitry to obtain said data and to determine whether the processing unit is compliant with the security policy.

Example 53: One or more non-transitory computer readable media comprising machine readable instructions which, when executed, perform the method according to any one of Examples 1-49.

Example 54: A computing system comprising the apparatus of any one of Examples 50 to 53.

Example 55: The computing system of Example 54, further comprising a processing unit.

Example 56: A computer program product for performing the method of any one of Examples 1 to 49.

1. A method of determining whether a processing unit is compliant with a security policy, the method comprising:
obtaining first data indicative of a power consumption profile of the processing unit for a first time period, the power consumption profile comprising a variation of power consumption with time; and
determining whether the processing unit is compliant with the security policy during the first time period depending, at least in part, on the obtained first data,
wherein the processing unit complying with the security policy gives rise to a power signature in the power consumption profile of the processing unit during a period of compliance.

2. The method of claim 1, wherein determining whether the processing unit is compliant with the security policy depending, at least in part, on the obtained first data comprises determining, depending at least in part on the obtained first data, whether the power consumption profile comprises the power signature.

3. The method of claim 1, wherein the processing unit is operable in each of a plurality of modes, each of said modes having a corresponding privilege level giving the processing unit respective selected access rights to system resources in that mode.

4. The method of claim 1, wherein the processing unit being compliant with the security policy comprises the processing unit transitioning between a lower privilege mode and a greater privilege mode.

5. The method of claim 1, wherein the security policy comprises executing, by the processing unit, at least one operating system in a virtual machine.

6. The method of claim 5, wherein the virtual machine is implemented utilising a hypervisor.

7. The method of claim 5, wherein the power signature comprises a characteristic increased power consumption during a period of compliance of the processing unit with the security policy.

8. The method of claim 3, wherein the plurality of modes comprises a first virtualization mode and a second privilege mode, the first virtualization mode having a greater privilege level than the second privilege mode, and wherein the security policy comprises utilising the first virtualization mode to execute, by the processing unit, an operating system in a virtual machine utilising a hypervisor.

9. The method of claim 8, wherein the power signature comprises any one of: a characteristic increased power consumption during a period of compliance of the processing unit with the security policy; a characteristic power spike or a plurality of characteristic power spikes during a period of compliance of the processing unit with the security policy; or any combination thereof.

10. The method of claim 8, wherein the power signature comprises a characteristic reduced power consumption for at least one processing core of the processing unit during a period of compliance of the processing unit with the security policy.

11. The method of claim 3, wherein the plurality of modes comprises a secure mode or a plurality of secure modes, and wherein the security policy comprises invoking the secure mode or the plurality of secure modes.

12. The method claim 11, wherein the power signature comprises any of:
a characteristic increased power consumption during a period of compliance of the processing unit with the security policy;
a characteristic reduced power consumption for at least one processing core of the processing unit during a period of compliance of the processing unit with the security policy;
a characteristic power spike or a plurality of characteristic power spikes during a period of compliance of the processing unit with the security policy, said power spike or spikes corresponding to invoking the secure mode or the plurality of secure modes.

13. Apparatus comprising processing circuitry to:
obtain data indicative of a variation of power consumption with time, the data relating to at least one processing core of a processing unit; and
determine whether the processing unit is compliant with a security policy depending, at least on part, on whether the obtained data is indicative of a power signature associated with a period of compliance with the security policy.

14. The apparatus according to claim 13, further comprising a memory storing instructions executable by the processing circuitry to obtain said data and to determine whether the processing unit is compliant with the security policy.

15. One or more non-transitory computer readable media comprising machine readable instructions which, when executed, perform the method according to claim 1.
